(19) United States
(12) Patent Application Publication
(10) Pub. No.: US 2007/0245321 A1
(43) Pub. Date: Oct. 18, 2007

(54) Computer games localisation

(75) Inventors: Derek Andrew Cosgrove, Dunfermline (GB); Steven Archibald Fullerson, Stonehaven (GB); Torfi por Gunnarson, Dundea (GB); James Varnum Terkeurst, Scotland (GB)

Correspondence Address: YOUNG & BASILE, P.C., 3001 WEST BIG BEAVER ROAD, SUITE 624, TROY, MI, 48084, US

(73) Assignee: University of Abertay Dundee

(21) Appl. No.: 11/728,076

(22) Filed: Mar. 23, 2007

Related U.S. Application Data
(63) Continuation of application No. PCT/GB05/03518, filed on Sep. 12, 2005.

(30) Foreign Application Priority Data
Sep. 24, 2004 (GB) 0421297.3

(51) Int. Cl. G06F 9/45

(52) U.S. Cl. 717/136

(57) ABSTRACT

A method for developing and localising software that involves receiving inputs from a software developer as part of a software development process, the inputs including one or more resource that is to be localised. When these inputs are received, they are stored in a central repository together with an identifier indicative of their location in the software being developed. Once this is done, a translator is allocated the task of localising the software, and the localisable resources are presented on a translator interface, ideally together with contextual information. These are then localised by the translator and stored in the repository. Whilst this is being done, the development process continues until the software or at least a part thereof is completed and all relevant localisable information is localised. Then, the software is tested in a run time environment in the original and the foreign languages.

### RELATED APPLICATION

This application claims priority to PCT Application No. PCT/GB2005/003518 filed on Sep. 12, 2005.

### FIELD OF THE INVENTION

The present invention relates to a system and method for localising computer games production. In particular, the invention relates to a system and method for providing for different language requirements during software development.

### BACKGROUND OF THE INVENTION

Computer games are widely available in many countries throughout the world. Many of these games include massive amounts of spoken language and/or written text. Typically the games software is written with all of the spoken language or written text in a first language, generally the language of the country of origin. Then, in the event that the software is to be sold in foreign language countries the spoken and written text is translated into the desired language. This is a process that is referred to as localisation. In addition to text, localised elements may also include sounds, images and other game resources.

Computer games localisation is an expensive and difficult process. Various methods that attempt to simplify this are described in U.S. Pat. No. 6,725,759 and WO00/38052. However despite some improvements, it is estimated that the cost of localising a single computer game for a single foreign language country can be of the order of one hundred thousand dollars, excluding translation and publishing costs. Clearly for games that have an international appeal, this makes extending the product market very costly. Another problem is that because the localisation process is typically post-production, it can introduce unanticipated errors, which means that in practice the games code and even the art and other games resources must be changed and re-compiled. This adds to the production time and complexity.

### SUMMARY OF THE INVENTION

An object of the present invention is to provide an improved system and method for localising software, and in particular computer games software.

According to one aspect of the present invention, there is provided a system for developing and localising software comprising a developer interface for receiving one or more localisable resource that is to be localised as part of a software development process; a repository for storing the one or more localisable resource as part of the development process together with an identifier indicative of its location in the software being developed; a translator interface for presenting one or more of the localisable resources that is to be localised and receiving localised resources input by the translator; and means for exporting the localised resources and in a format that is suitable for the software that is being developed.

By providing an integrated localisation system for use by developers and translators, the localisation of resources can be made part of the development process, thereby reducing the time and effort needed for the typical post-production approach. This improves accuracy, whilst reducing the time to localise software and the associated costs.

The system may include a component for identifying and organising localisable resources and depositing them in the repository. The system may include a component for allowing remote access and alteration to the repository's resources including communication about and identification of specific and/or changed resources. The system may further include a managed component for allowing full access to both original and changed game resources within the repository for use in creating a localised product.

The system may be operable to receive from the developer contextual information relating to the localisable resource; store that contextual information in association with the localisable resource and provide the contextual information at the translator interface in association with the corresponding localisable resource. The contextual data may comprise one or more text files and/or one or more images and/or one or more audio files.

A plurality of translators may be available and the system may be configured to allocate one or more localisable resources to a designated one of the plurality of translators for localisation.

According to another aspect of the present invention, there is provided a method for localising software that is under development, preferably a computer game, the method comprising: receiving one or more localisable resource input at a developer interface; storing the one or more localisable resource in a repository; presenting at a translator interface a resource that is to be localised; receiving localised resources input by the translator, and importing the localised resource into the software under development.

The method may further involve receiving from the developer contextual information relating to the localisable resource; storing that contextual information in association with the localisable resource and providing the contextual information at the translator interface in association with the corresponding localisable resource.

Preferably, a plurality of translators is available and the method comprises allocating one or more localisable resource to a designated one or more of the plurality of translators for localisation.

The method may involve monitoring progress and/or quality of output of each translator.

The method may involve sending to the translator a message with notes or comments relating to a localisation that is in progress and presenting the message in the translator interface. Alternatively or additionally, the method may involve storing a note on a given localisable resource that is currently being localised in association with that resource and presenting the note in the translator interface. By doing this, a fully interactive process is enabled, in which information and comments from developers can be sent to translators whilst resources are being localised, and as part of the on-going development process.

In practice, the method ideally involves localising the localisable resources into two or more languages or cultures.

### BRIEF DESCRIPTION OF THE DRAWING

Various aspects of the invention will now be described by way of example only and with reference to the accompanying drawings, of which:

FIG. 1(a) is a block diagram of an integrated computer games development and localisation system;

FIG. 1(b) is a modified version of the integrated computer games development and localisation system of FIG. 1(a);

FIG. 2 is a schematic view of the systems of FIGS. 1(a) and (b) from the perspective of a software developer;

FIG. 3 is a view of a page for allowing a software developer to enter localisable resources that are to be localised;

FIG. 4 is a view of an application string input screen;

FIG. 5 is a view of an application metadata input screen;

FIG. 6 is a view of an application import data screen;

FIG. 7 is a schematic view of the system of FIG. 1 from the perspective of a translator and a manager;

FIG. 8 is a map of the web site for allowing managers and translators to interact with the system of FIG. 1;

FIG. 9 is a view of a menu page for use by a manager and/or translator;

FIG. 10 is a view of a login page;

FIG. 11 is a view of a project selection screen;

FIG. 12 is a view of a project overview screen;

FIG. 13 is a view of a project overview screen for a single language;

FIG. 14 is a view of a task organiser screen;

FIG. 15 is a view of a project task assignment screen;

FIG. 16 is a view of a translation overview screen;

FIG. 17 is a view of a main translation page for allowing translators to enter localised resources;

FIG. 18 is a view of the translation screen of FIG. 17, in which an image overlies the main grid;

FIG. 19 is a view of the translation screen of FIG. 17, in which a message overlies the main grid;

FIG. 20 is a view of a first user management screen;

FIG. 21 is a view of a second user management screen;

FIG. 22 is a block diagram of a web interface for implementing the system of FIGS. 1 to 21;

FIG. 23 is a diagrammatic representation of various interlinked tables that are provided in the database of FIG. 1, and

FIG. 24 is diagrammatic representation of a data file structure for importing data into the data localisation database of FIG. 1.

### DETAILED DESCRIPTION OF THE ILLUSTRATIVE EMBODIMENT

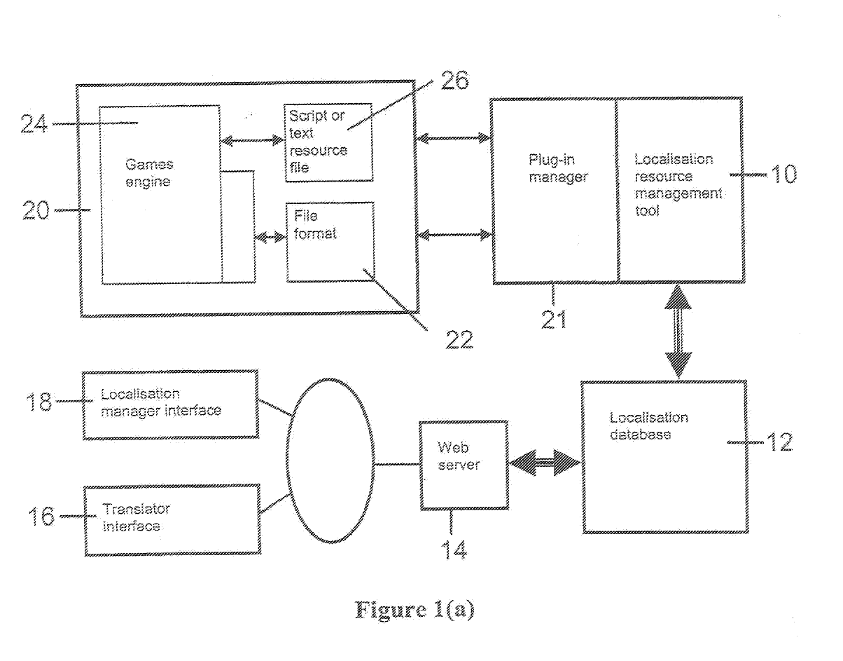

FIG. 1(a) and 1(b) show a localisation system that includes a localisation resource management tool 10 for controlling a localisation process and allowing localisable resources to be input by a developer. This system is adapted to be used in association with a software development/authoring tool (not shown) in which the software is developed. Typically, either during the development process or once a first version of a program is completed, the developer identifies resources that are to be localised and enters these into the localisation system of FIG. 1. To allow this, the system includes a developer interface, which is typically presented on, for example, a PC (not shown) that is connected directly to the localisation resource management tool 10. All localisable resources entered by the developer are managed by the localisation tool 10 and included in a localisation database 12. These resources may include text and/or audio files, as well as any additional information relating to that resource, for example sound and images. Connected to the localisation database 12 is a web server 14 that includes software for generating a translator interface 16 and a localisation manager interface 18 for allowing translators and managers respectively to interact with the localisation system and in particular the localisation database 12. Using the translator interface 16, translators can be presented with resources that have to be localised and subsequently enter translated/localised versions of those resources.

To allow communication between the localisable resource management tool 10 and a games runtime environment 20, a plug-in manager 21 is provided. The plug-in manager 21 for any given system has to be operable to provide the localised information from the localisation system in a format that is suitable for inclusion in the main program that is being developed. The exact nature of the plug-in will therefore depend on the main software development tool that is being used, although the high level functionality of each plug-in will be the same. More specifically, the plug-in has to be operable to convert the localised project file into a file format 22 that is recognisable by the game engine that is being used by the developer. In addition, the plug-in has to provide a script or text resource file 24 that includes the localised text. The file format and resource files provided by the plug-in can then be used by the game engine to build /compile the localised software.

The plug-in manager can communicate with the game engine 24 either directly, as shown in FIG. 1(a), or through a source code management system (SCM) 28, as shown in FIG. 1(b). Source code management systems are often used in software authoring environments for managing and related assets. SCM systems are well known in the art and so will not be described in detail.

In order to allow developers, managers and translators access to the system various different user interfaces are provided. Each of these will be described in turn.

The Developer Interface

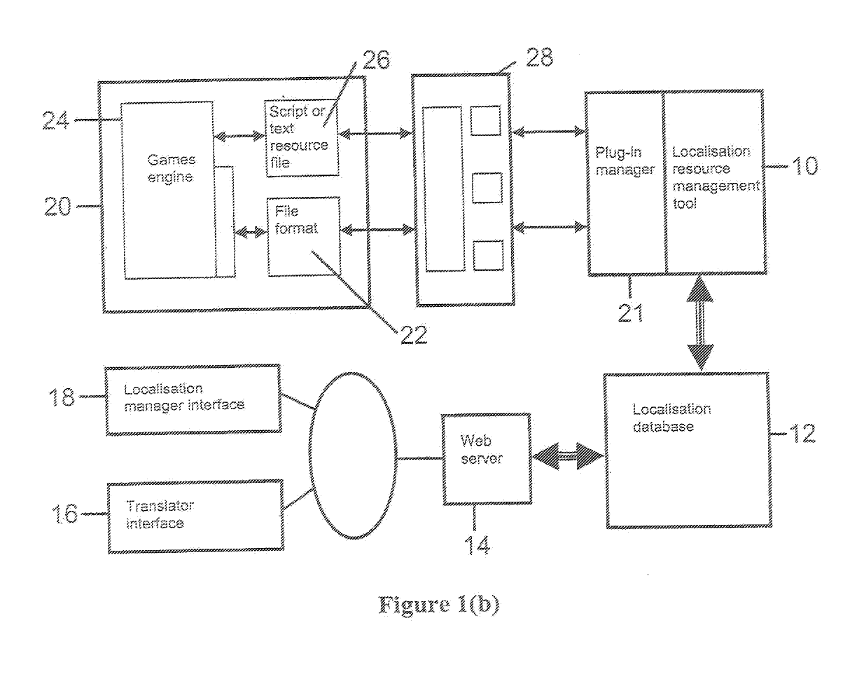

The developer interface to the database is a windows application for allowing the developer to input resources that are to be localised. FIG. 2 shows the main functions that are accessible by the developer via the developer interface. These include creating a new localisation project; managing localisable resources; managing localisable resource data; importing data from a specified file format and exporting data to a specified file format. The developer interface can take any suitable form, but should include various selectable options such as “create new project” and “open existing project”. When the developer wants to create a new project, the “new project” option is selected. This causes the user to be prompted to enter some basic project information such as project name. At this stage the interface software is operable to ask the user to list other users who have security right to modify this new project.

Once the new project information is entered, the interface presents the user with a new project root node. The developer is then able to manage localisable resources. For example, the interface is operable to allow the developer to add/delete/modify localisable resources. When added, each localisable resource is associated with a unique identifier that enables identification of its location in the project file. The interface allows the user to manage localisable resource metadata, i.e. additional information relating to the localisable resource that may be useful to the translator. As examples, the interface allows the developer to associate a sound and/or an image with the localisable resource to clarify the context. The localisable resource with any associated data is then imported to the localisation database 12 where it is made available for localisation. This can be done at any stage in the development process. Once the localisation is completed, the localised resource is exported back into the project file. Because each localised resource is provided with an identifier, when it is exported back, the main application knows where to insert it in the project file.

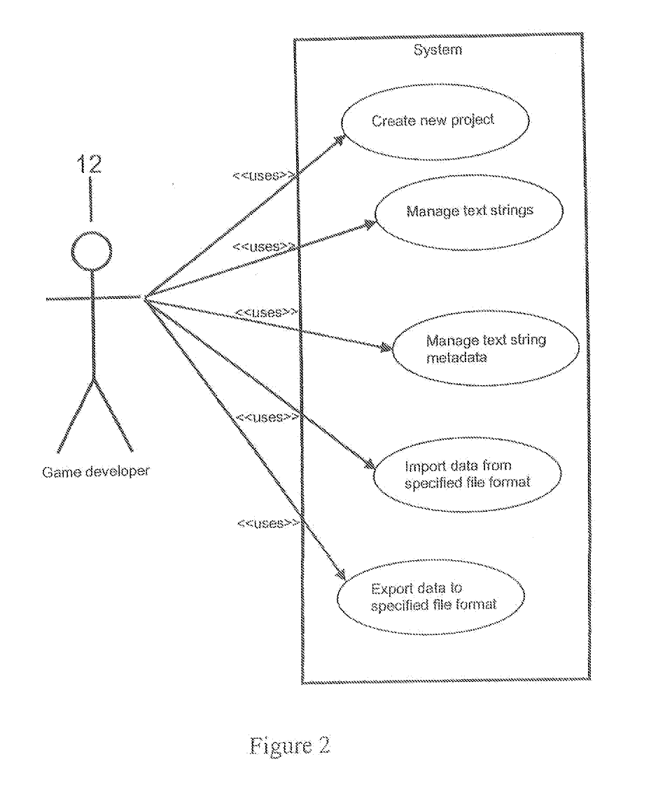

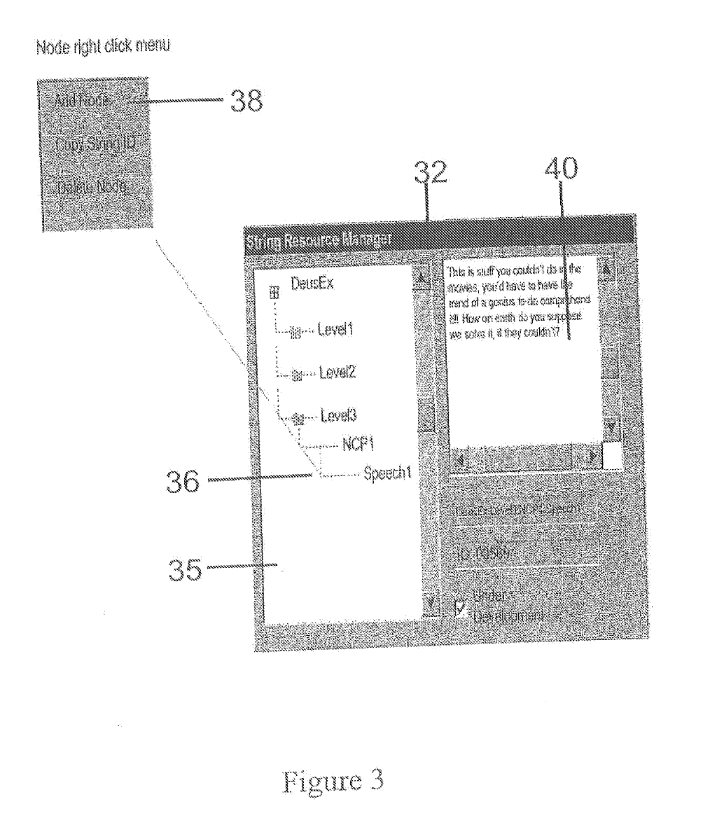

The developer interface is operable to allow developers to structure their data in a tree view display and arrange tree nodes, which are specific to a particular game. FIGS. 3 and 4 show screen shots of pages of the developer interface. In this case, the left hand side of the screen view 35 shows the tree structure of the game being developed. By selecting an existing node of the tree 36 and using the right click “add node” option 38, the developer can add a localisable resource that is to be included in the game. Where this resource is text, it may be entered via the text field 40 on the right hand side of the screen. For example, in the case of FIG. 3, the developer has entered the following speech: “This is stuff you couldn't do in the movies, you'd have to have the mind of a genius to comprehend it! How on earth do you suppose we solve it, if they couldn't?”.

Each added localisable resource is assigned a unique ID so it can be referenced from the game code. This ID is stored in association with the localisable resource within the game software and when the localisable resource is exported to the localisation database for localisation translation. The same ID is used to allow the relevant localised version of the text to be identified. In this way, the localisable resource can be mapped to a localised resource internal within the database 28.

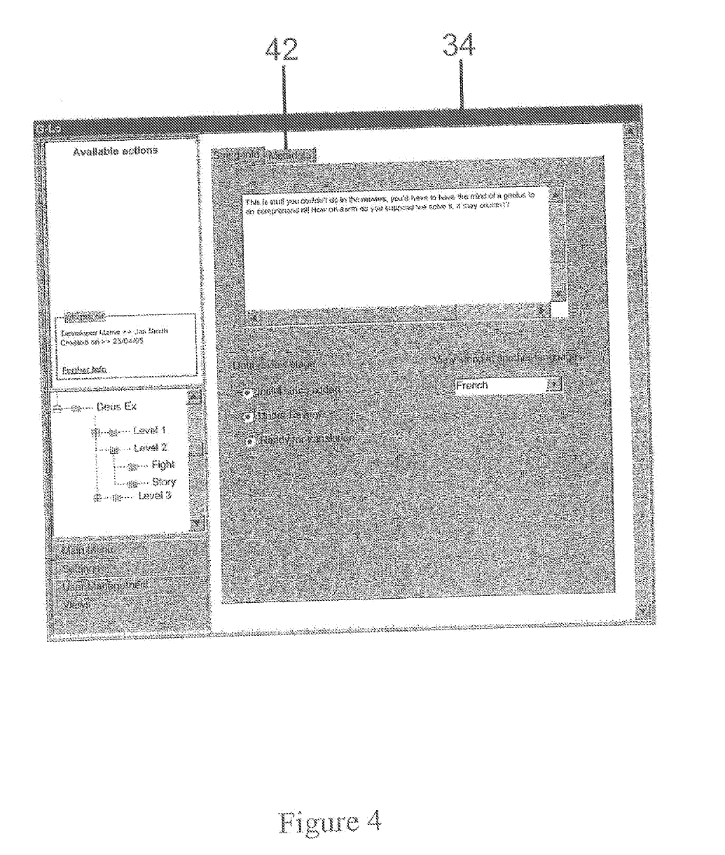

To enhance localisation, the developer interface allows the developer to associate metadata with their localisable resources. To do this, the interface includes a “metadata” tab 42, as shown in FIG. 4. Selection of this causes the page shown in FIG. 5 to be displayed. This presents a field 44 for allowing additional notes to be added to set the scene or explain the context for the translator, for example in this case “the character will be speaking to many people in the game, in a slightly aggressive manner . . . ”. In addition to this, the interface of FIG. 5 also allows images and sounds to be attached to or associated with the localisable resource, so that these can be used to further enhance the metadata. In practice, the onus will be on the developer as to where metadata is required for accurate localisation. However, because of the integrated nature of the development/localisation system, translators are able to send messages to request metadata where game environment context needs to be clarified. This will be described in more detail later.

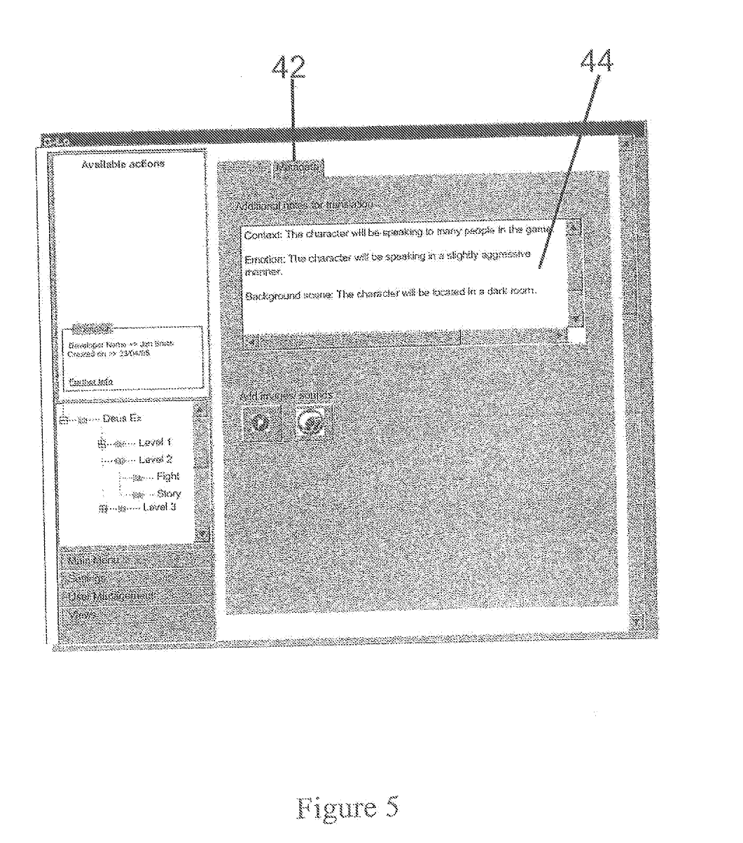

Once the developer has entered the localisable resources from a new or existing game into the loacalisation database, the file is imported into the repository 12, together with any associated metadata. To do this an “import data” screen 46 is provided, as shown in FIG. 6. This has a browse facility 47 for allowing a developer to identify the project file of interest and a data entry field 48 that allows selection of a file that is to be imported. Also provided is a user selectable “IMPORT” button 50, which when selected automatically imports the selected file into the localisation database 12.

Manager and Translator Interface

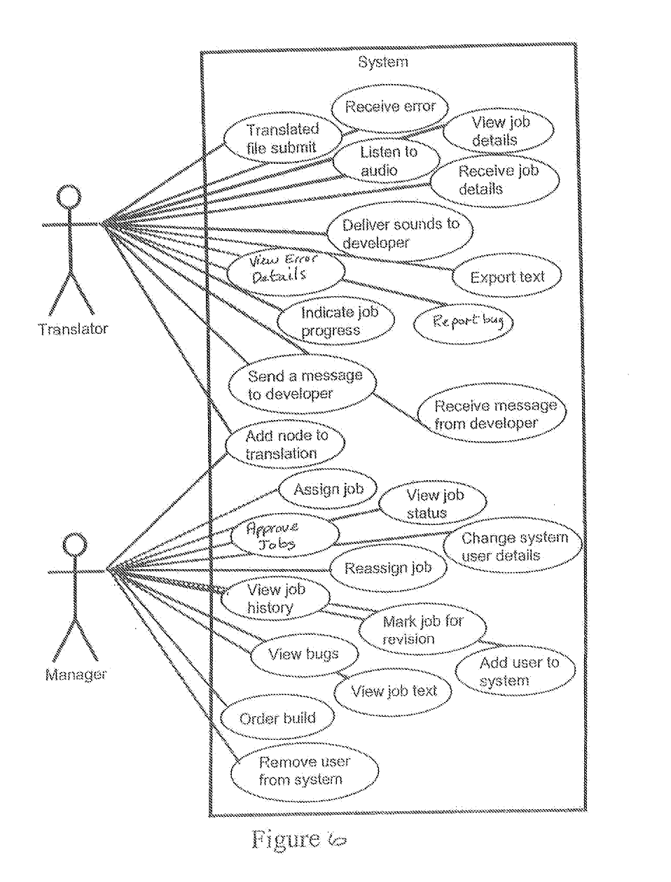

Importing data into the localisation database 12 triggers the commencement of the localisation process. This involves the interaction of a manager and one or more translators. The functions and activities of the manager and the translators are shown in FIG. 7. In general, the manager allocates jobs to a selected one of the translators, checks on progress and quality and if necessary re-allocates jobs. The translators receive job details and localise the localisable resources provided in the localisation database, whilst taking into account any metadata that is provided.

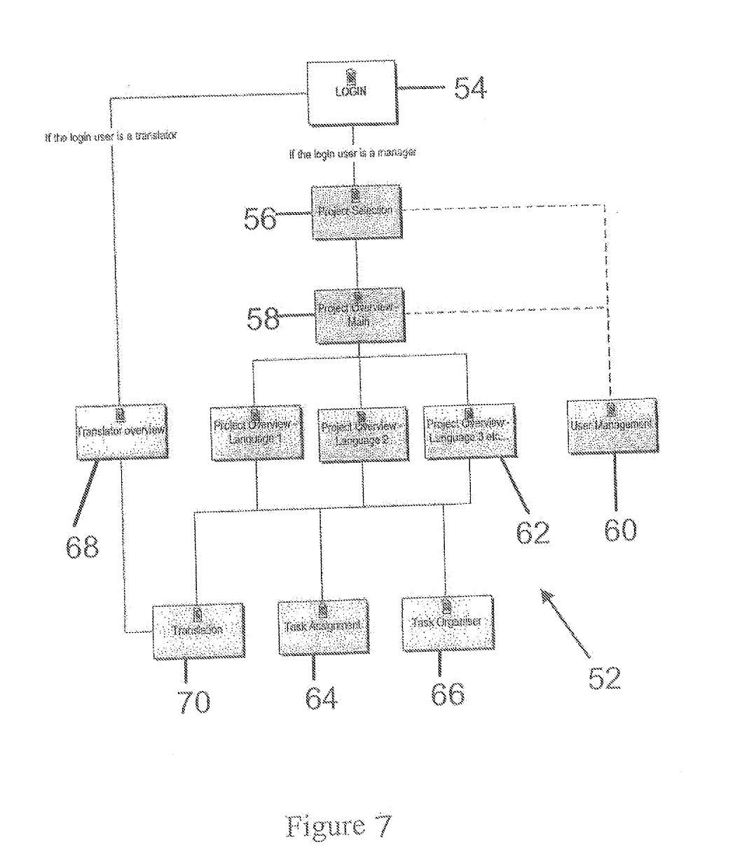

FIG. 8 shows the overall structure of the manager/translator site 52, with only the main pages shown. This includes a login page 54 that is operable to identify the category of user for example manager or translator. In the event that the user is identified as a manager, this provides access to a project selection page 56, which optionally allows the manager access to a project overview page 58 or a user management page 60. The user management page 60 allows the manager to manage the users on the system, such as their passwords and access permissions. This screen is accessible from both the project selection and project overview pages 56 and 58 respectively. The project management overview 58 provides statistics on the original resources and shows tabs for easy access to different localisations (sub-projects) 62 for the current project. Linked to each of the project specific pages 62 are task assignment and task organiser pages 64 and 66 for allowing the manager to allocate and organise tasks. In the event that the user is identified as a translator, access is provided to a translator overview page 68, which lists all projects the identified translator is working on. Linked to the translator overview page 68 is a localisation page 70, within which actual localisation work is conducted. Each of these will be described in more detail.

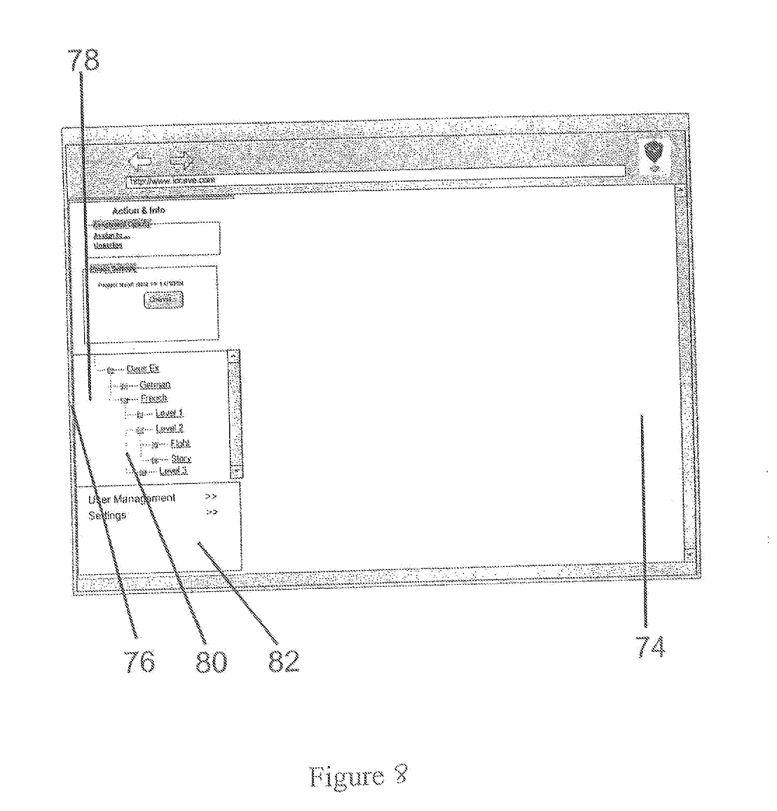

FIG. 9 shows the general form of the screen 72 that is the primary access for translators and managers. This is divided into a main area 74, and a control panel 76 on the left hand side. The control panel 76 includes a context sensitive area 78, which changes depending on which page of the interface is currently being viewed, together with relevant information and various selectable actions. Also included in the control panel 76 is a tree structure 80 of the currently selected project. This is displayed for easy navigation around the project. When a node in the tree 80 is clicked, the relevant screen is displayed in the main screen area 74. At the bottom of the control panel 76 is the main menu 82 with commands to navigate to certain pages, and other common commands that apply to the whole system.

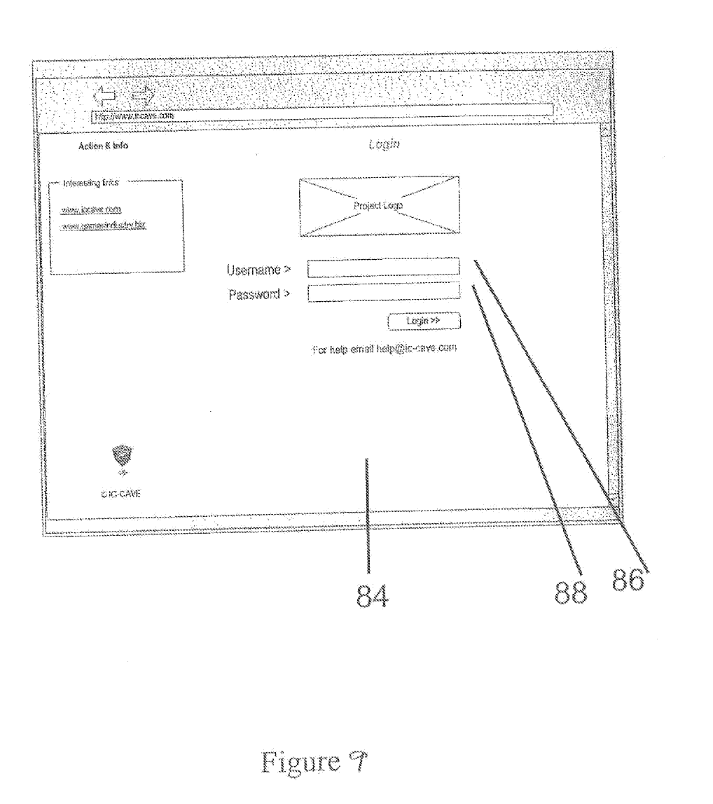

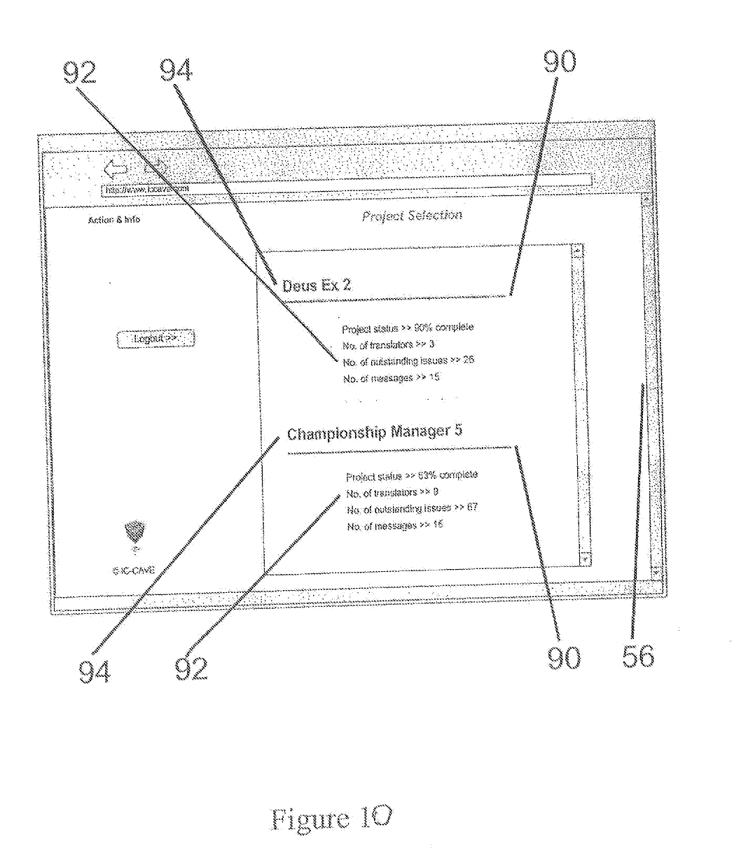

FIG. 10 shows the login page 84 where users are able to log into the system by entering a user name and password into user name and password fields 86 and 88 respectively. There is also a link to an email address for help if login fails. The next page that is displayed is either the project selection page 56 if the user is a manager, or the task selection page 68 if the user is a translator. An example of the project selection screen 56 is shown in FIG. 11. This displays all the projects 90 that are in the localisation database, and statistics on them 92. The statistics 92 include project status, which is a number expressed as a percentage indicating how many resources as a part of the whole project have been localised; a number indicating the number of translators who have tasks from that project assigned to them; a number indicating the issues currently unresolved in that particular project, and a number indicating the number of messages that have been sent regarding tasks in that project. In the examples shown in FIG. 11, it can be seen that for the project titled “Deus Ex 2” the project is more than 90% completed, three translators are working on it, twenty six issues are outstanding and fifteen messages have still to be dealt with. In contrast for the project named “Championship Manager 5”, the project is more than 63% completed, nine translators are working on it, sixty seven issues are outstanding and fifteen messages have still to be dealt with.

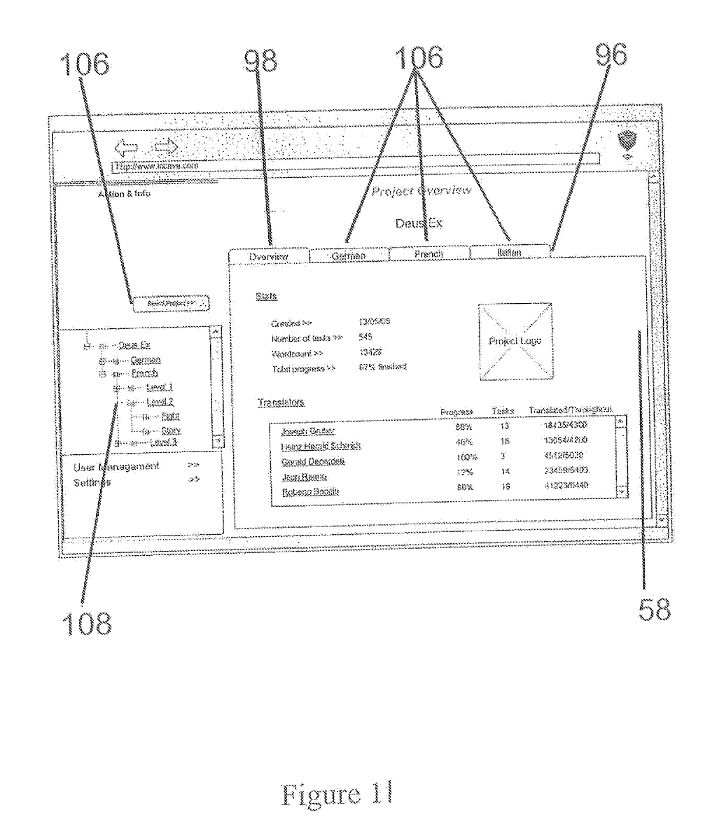

In the screen of FIG. 11, each project name 94 is a link to a selection of that project. Selection of a particular project causes the project overview page 58 of FIG. 12 to be displayed. This screen 58 has a tab control 96 where the options are to display an overview of the currently selected project 98 or select a language for statistics and options on each respective language version of that project 100. Selection of the overview tab 98 causes statistics concerning the whole project to be displayed, for example, the date of creation of the project, the number of tasks defined within that project, the number of resources that have to be localised, a number, typically a percentage indicating how many resources have been successfully localised, and a list of translators who have been assigned tasks. Within the translators list is the name of the translators, a number that is representative of the progress that has been made, the number of tasks completed and a number indicative of the average number of resources a day localised by that translator.

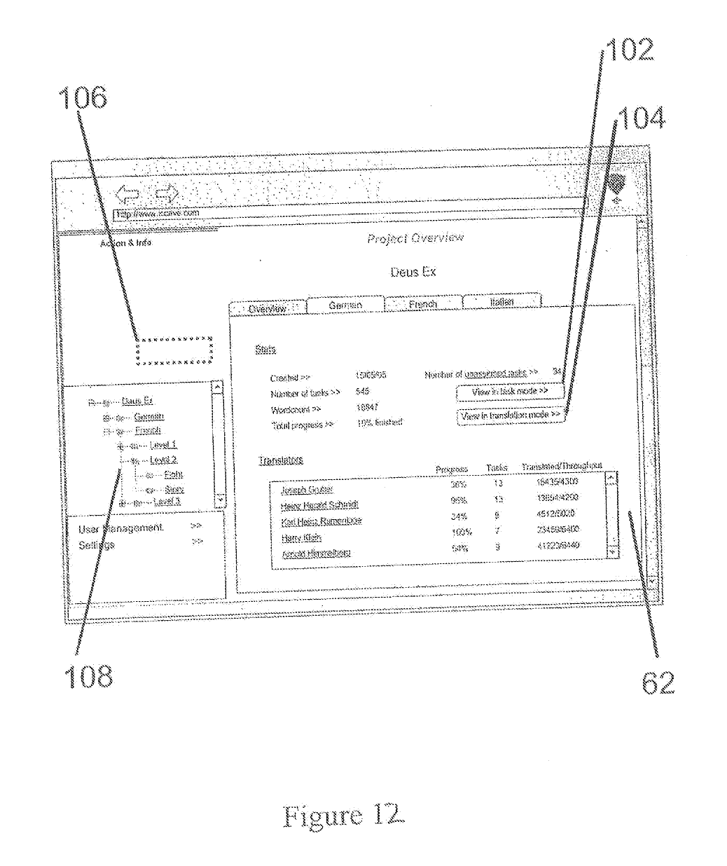

In the project overview page 58 shown in FIG. 12, there are three language tabs 100. Selection of any one of these provides essentially the same information as the overview tab 98, but restricted to information for that particular language. FIG. 13 shows the page that is presented when the “German” tab 100 of FIG. 12 is selected. This includes two new buttons, one 102 allowing the current project (language version) to be viewed in task mode and one 104 allowing the project to be viewed localisation mode. In the overview and language pages of FIGS. 12 and 13, a select project button 106 is provided to allow the manager to move between projects. Also provided is a tree 108 that allows the user to travel to any language version of a project and to any screen, all depending on the level of the chosen item in the tree.

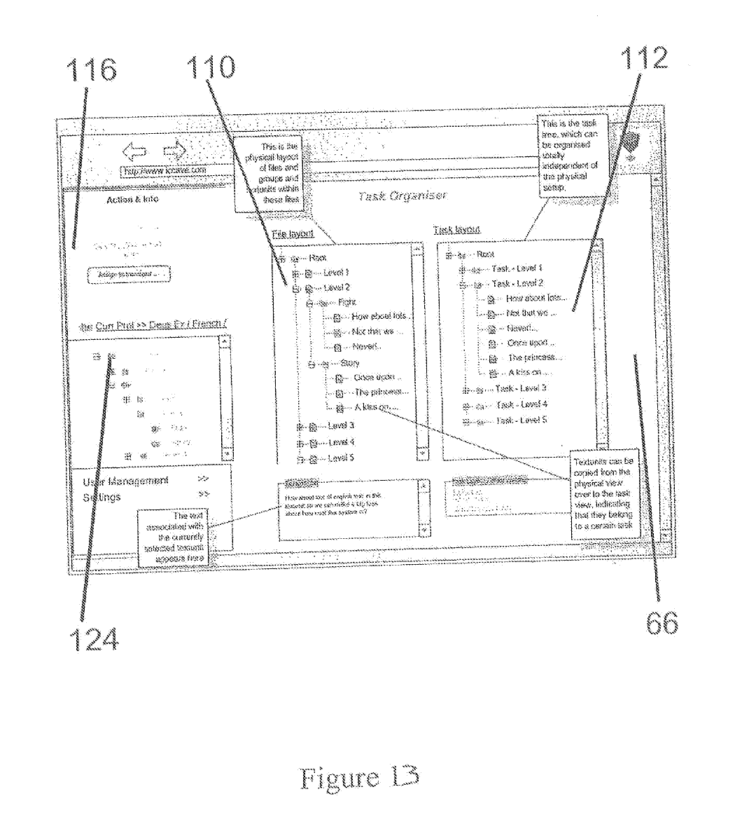

FIG. 14 shows a task organiser page 66. This is accessible from a tab on the project overview page 58 labelled “unassigned tasks”. This allows the manager to organise the localisable resources into groups of tasks, to move the resources between tasks, remove them from tasks, and create, edit and delete tasks. This is done with a drag-and-drop tree interface. The interface consists of two tree views displaying the project file layout (physical layout) of the localisable data in the database 110 and the task layout 112 or how the localisable resources have been organised into tasks.

The task layout tree 112 is a virtual view of the data. It is a construct to organise the tasks in a different way from the physical file layout structure 110. The file layout tree 110 has file nodes 114, which represent physical files (for example the way the files are organised when they are imported into the database, or created, and also when they are exported again), and also nodes that represent logical parts of those files, as well as individual localisable resources as leaf-nodes. The task layout tree 112 is originally constructed to imitate the file layout tree 110 exactly, but can be changed, for example by deleting, moving or creating nodes. The task organiser page 66 is operable to allow the leaf-nodes from the file layout tree 110 to be dragged and dropped anywhere onto the task layout tree 112. The leaf nodes can also be moved back and forth within the task layout tree 112. In contrast, the structure of the project file layout tree 110 cannot be changed, unless the user has special edit rights.

Included in the task organiser page 66, in the Action & Info box 116, are three buttons—one to clear the task layout tree 118, one to copy the file layout tree to the task layout tree (done automatically when the project is created) 120, and a button to assign a task to translator 122. These buttons are available only to users with special rights to use them, for example managers. There is also a folder indicating which project is currently active. This can be clicked to take the user to the Project overview screen. The tree on the left 124, which can usually be used for navigation, is greyed out and unusable, because it is being modified by the task organiser screen the user is currently in. As an alternative the user can click the relevant leaf-node or task-node in the file layout tree 110 or task layout tree 112 to be moved to the relevant screen.

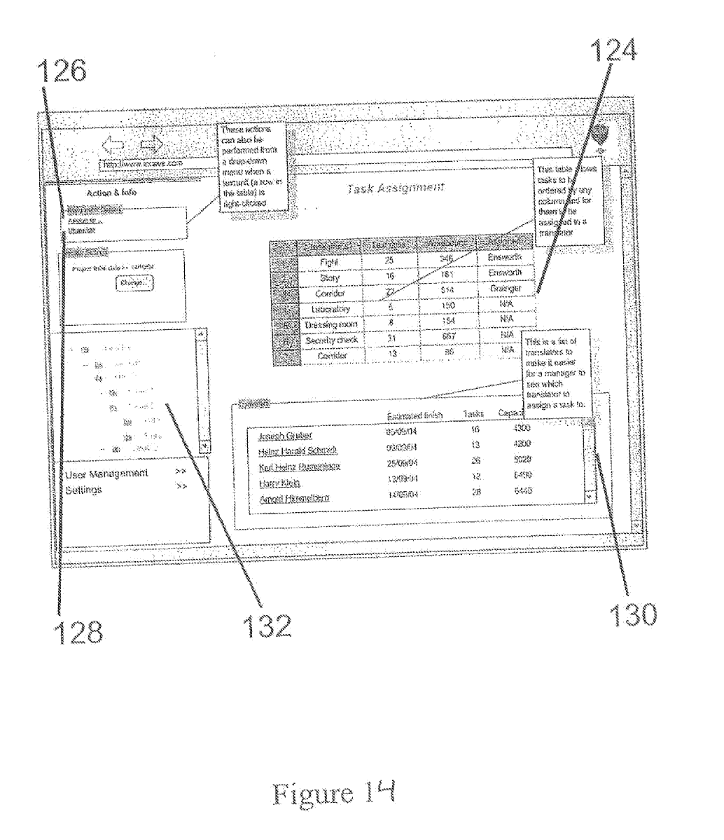

Selection of the “assign task to translator” button 122 in the screen of FIG. 14 causes the task assignment page 64 of FIG. 8 to be presented. This is shown in more detail in FIG. 15. This screen 64 allows the user to view all tasks associated with a project currently selected. The information is displayed in a table 124 that allows for easy sorting of the tasks in any order desired. The manager can select multiple tasks and assign them to a translator, as well as unassign them. The basic; functions “Assign to” 126 and “Unassign ” 128 are displayed in the Action & Info area, together with the project finish date. This finish date is used as a trigger to cause warnings on estimates of time taken by translators to finish tasks if they run over this finish date. The box 130 at the bottom shows a list of available translators and their statistics. The statistics are the same as in the project overview page 58 of FIG. 12. The tree 132 on the left can be used to navigate to the project overview screen, the task organisation screen or the localisation screen, depending on which level of the tree is selected.

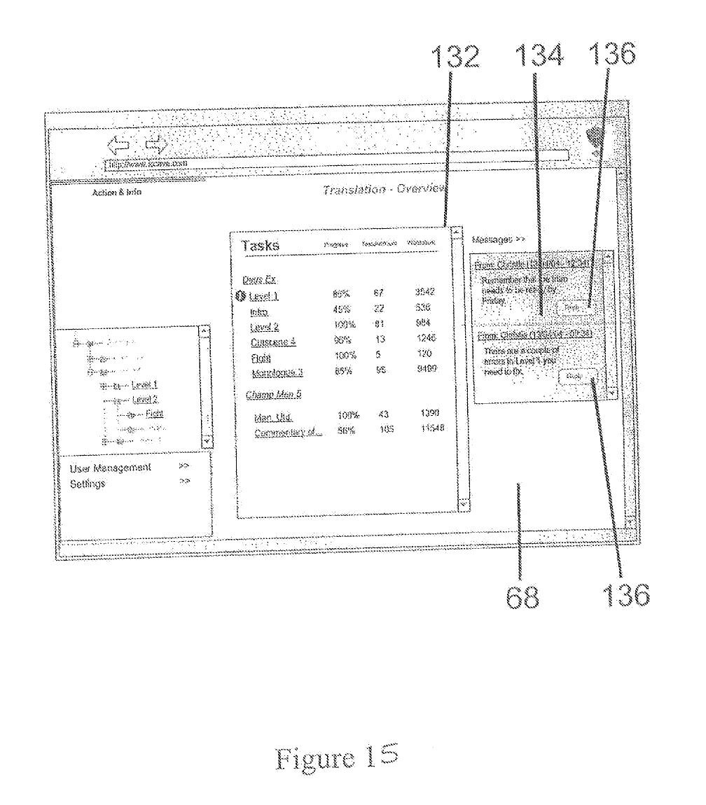

FIG. 16 shows the translator or localisation overview screen 68 of FIG. 8. This is the first screen presented to translators when they log in. The localisation overview 68 is for users who do not have any task organising or project organising rights and should only work on localisation. This screen 68 shows a user a summary 132 of all the tasks assigned to him/her. It also shows statistics linked to each task, such as how much of the current task has been successfully localised, in percentages; how many localisable resources there are within the job, and how many words there are. Optionally, it may also include a status-icon next to a task (not shown), indicating that the task needs attention. The box on the right 134 has messages to the current user. These messages either come from other users in the system or are system notifications. The translator can receive feedback via these messages regarding localisation bugs found during localisation testing. A reply button 136 is provided to allow users to reply to these messages, unless it is a system message. Provided on the left of the screen is the usual tree structure, which allows the user to see his assigned tasks in the project tree, in relation to the project structure and other tasks. It also allows the user to select these tasks in the same way as in the main view.

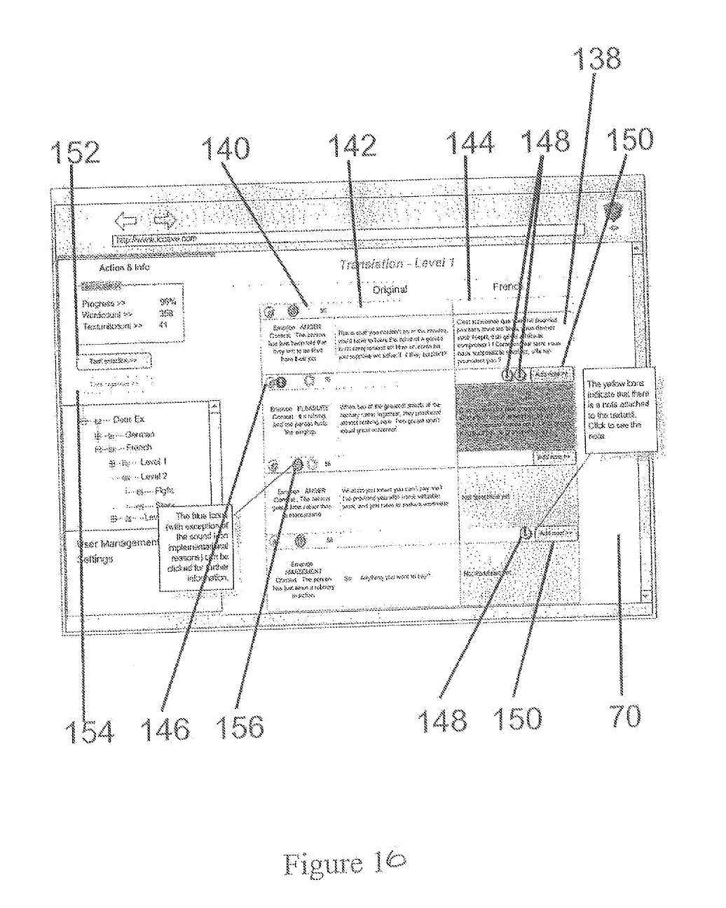

FIG. 17 shows the localisation page 70 of FIG. 8. This is the page that translators are directed to from the translator overview page 68. This page 68 is used to localise all the localisable resources within a given task. The localisable resources appear in a list (grid) 138 where a description of the scene within the computer game is described in a first box 140. Next to this are two further boxes, one 142 for the original resource, which as an example is in English, and one 144 for the target language. Originally all the boxes 144 for the secondary target language, in this case French, are coloured grey, with the resource “Not localised yet”. As soon as the user clicks on one of the target language boxes the focus shifts to that selected box and the user is able to edit it at will. The icons 146 above each localisable resource indicate the status of the resource and whether it has extra information or metadata attached to it. This extra information can initially be an attached image, an attached text or a sound file. Above the secondary or target language there may also be an icon 148, which indicates that a note has been added to the localisable resource by the current or another user. There is also a button 150 for allowing a new note to be added. The software is operable to present a warning to the translator if the translated text string resource entered exceeds any specified limit.

On the left of FIG. 17 in the Action & Info area are statistics indicating progress, word count and localisable resource count in the current task being worked on. There is also a button 152 for allowing the user to move to the task selection screen, and another one 154 for allowing the user to move to the Task organiser screen (although this option will typically only be available to managers). The tree on the left is such that it allows the user to move between tasks and even projects (if the user has access rights to that).

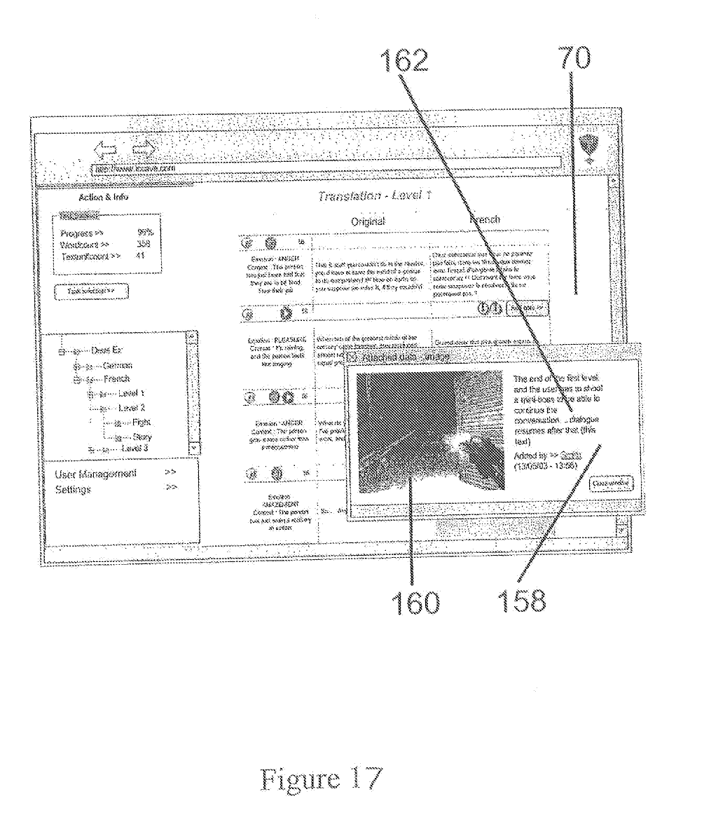

As described previously in connection with the developer interface, various types of metadata can be attached to each localisable resource, including images and sounds. To allow these to be viewed from the localisation page, suitable file icons 156 are provided within the grid. Clicking on the appropriate icon 156 causes a popup window to appear. For example, selection of a picture file would cause an image to be presented to the translator. FIG. 18 is a screen shot showing pop-up window 158 that includes an image 160 together with some additional text 162, describing the context in which the resource is to be presented.

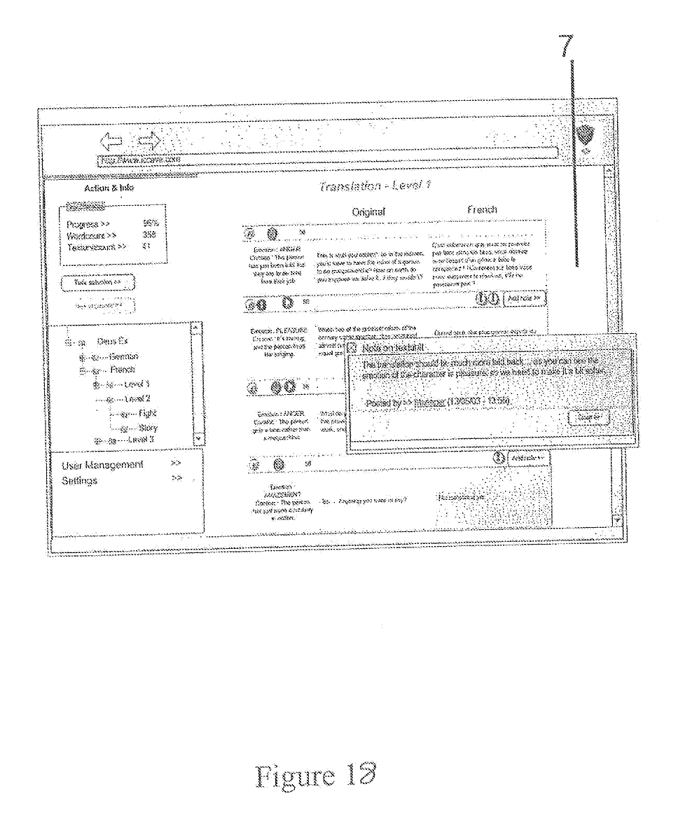

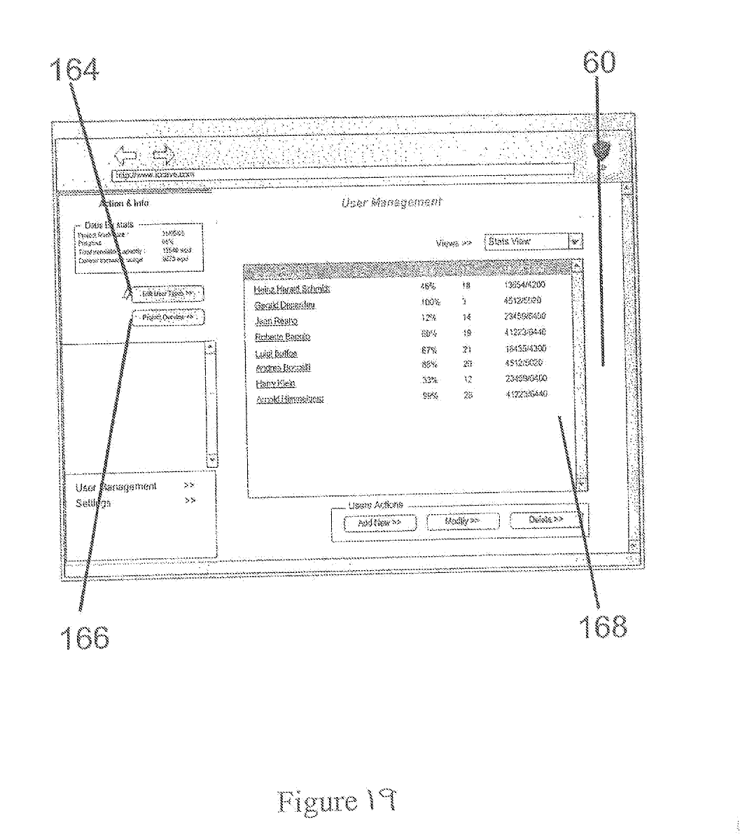

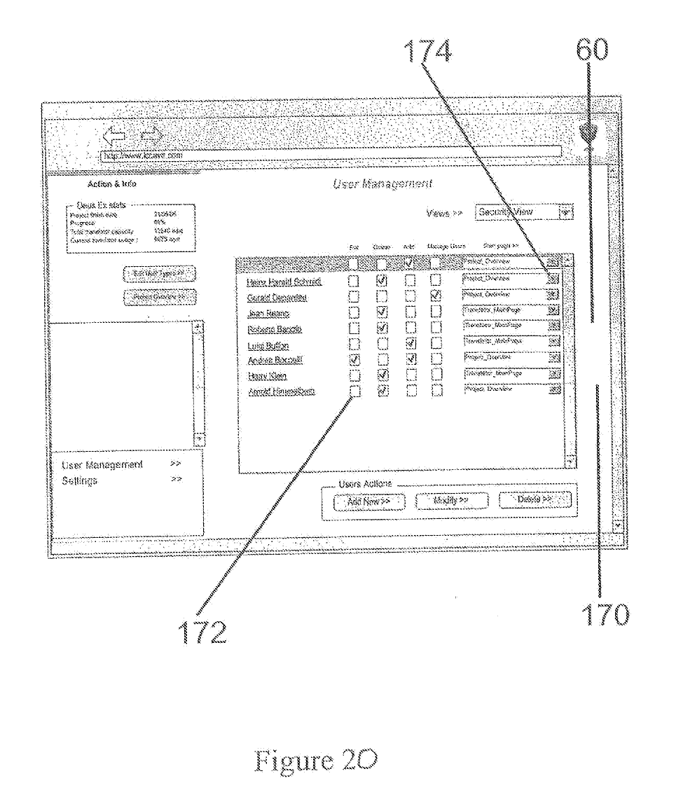

In order to allow feedback and interaction between users, a messaging facility is provided. Also provided is a note system, which allows notes to be attached to text units rather than directed to a specific user. These notes can be viewed from the translation screen 70 by clicking the note-icon next to a localisable resource. FIG. 19 shows a message that has been sent to the translator indicating that the localisation should be more “laid back” to reflect the emotion of the character. To open notes or messages, the interface of FIG. 19 includes various icons marked“!”. Selection of any one of these allows a message or note to be displayed. FIGS. 20 and 21 show user management screens 60, which can only be accessed by authorised managers. The Action & Info panel on the left of each of these pages shows statistics about the currently active project. This panel also includes two buttons 164 and 166, one for allowing user types to be changed 164 and one for taking the user back to the project overview 166. In addition to this, FIG. 20 shows a list of all users in the system 168 and allows the user with manager rights to add and remove users, as well as modify their details. This is the stats view, where the same statistics as on the Project overview screen are shown. FIG. 21 shows another user management screen, this time a security view 170. In this case, the access and amend rights of users can be viewed and edited. In this example, user access rights are indicated with checkboxes 172. These checkboxes can then be checked or unchecked to change the access rights. There is also a dropdown box 174 specifying which page the user sees after the login page.

In use, the translator sees a list of all tasks in progress. The translator selects a task and works on the various components. As the localisation work is completed, the localised resources are automatically entered into the repository 12. Once approved the developer has immediate access to the newly localised resources in the repository 12. The task status is updated to “finished” and the manager is informed via a message.

Web Interface Application

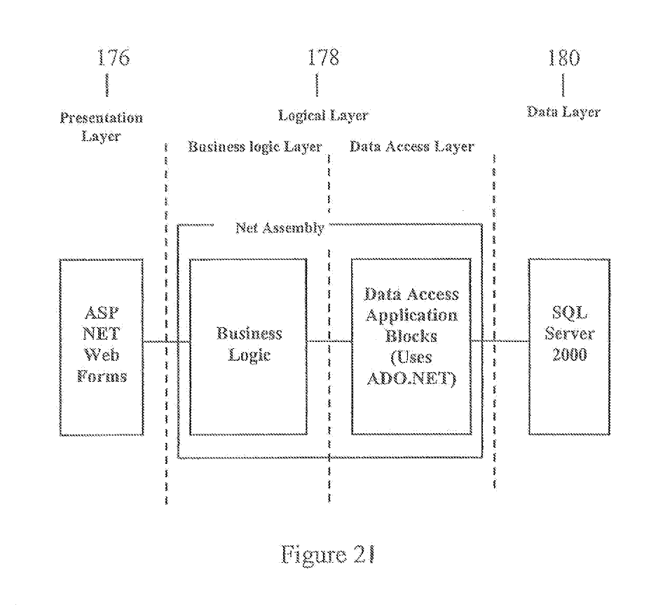

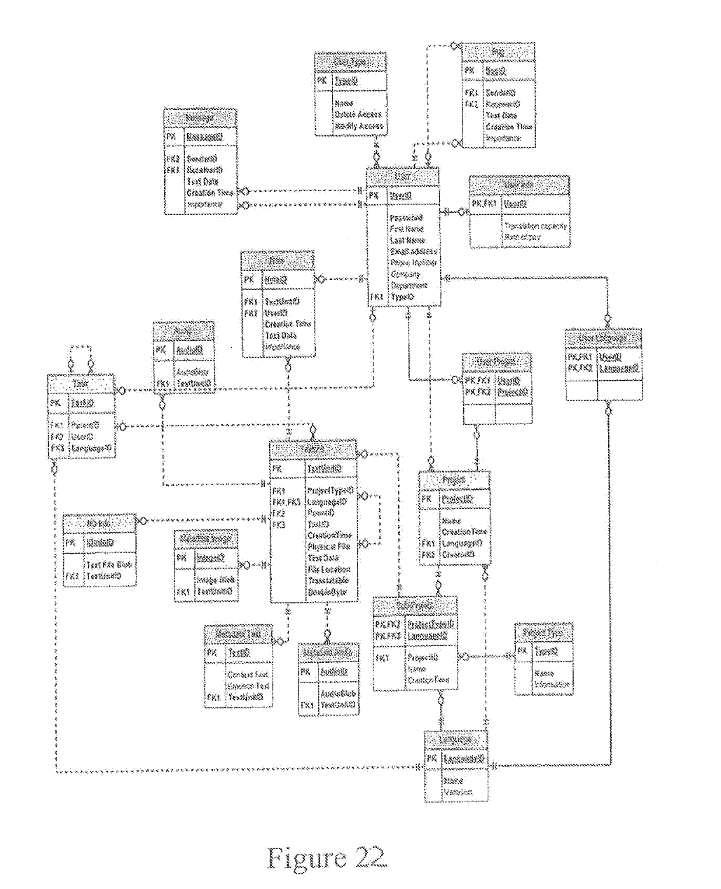

In order to implement the system in which the invention is embodied, a Web Interface application is used. This is a logical, 3-tier application with each layer held in its own namespace. These tiers include a presentation layer for providing the web-based translator and manager interface pages 176, an intermediate layer to facilitate access to the repository 178 and a data layer 180, which refers to the database access codes and any stored procedures. This is shown in FIG. 22. Lightweight data classes are used for the interface between the intermediate layer and user interface layer, i.e. the presentation layer. Authorisation is dealt with by a role-based security. As described previously, localisable resources are held in a database 28 so that translators can access resources easily and enter versions for various languages. The data localisation database may take any suitable form, but one example is illustrated in FIG. 23. In this case, the database includes nineteen interlinked tables.

There are three main types of user of the localisation system, these being developers, managers and translators. Each has different access rights to the system. To accommodate the different categories of user, three information tables are required: (1) a User table, which includes information that is available to all common user type fields; (2) a User Type table, which includes information on the different types of users and (3) User Information, which includes additional information about specific users, e.g. for translators, their rate of pay etc. The information in these tables is used to determine what information/interfaces a given user can access.

The basic table for holding text for translation is the Textunit. This includes various identifiers. For example a ParentID for linking the text that is to be localised back to the parent file; a TaskID for identifying the task that the unit belongs to; a LanguageID for identifying the language that the unit is held in and a Projecttype ID that identifies the type of project the text belongs to. Various tables are linked to the Textunit table. These include several Metadata Tables, such as a Metadata Text table, which includes a textual description of the context; a Metadata Image table, which includes an image file for setting the scene, and a Metadata Audio table for storing an audio file. Also linked to the Textunit table is an Audio table, which includes the text of any audio files that may require translation.

When text is input into the Textunit, it is necessary to hold some input/output details for sending back the translated version. Therefore, linked to the Textunit table is an I/O Info table. This includes an identifier that is indicative of the location of the localisable resource in the software that is being developed, and so the location at which the localised resource has to be inserted in the run time environment. To allow notes to be stored, a Note table is optionally attached to each Textunit (TextUnitID) by a user (UserID) working on that textunit. This table has a NoteID for identifying the note; a TextunitID for identifying the appropriate text unit; a UserID indicative of the user for whom the note is intended; the time the note is created (Creation Time), the note details (Text Data) and an indication of the importance of the note (Importance).

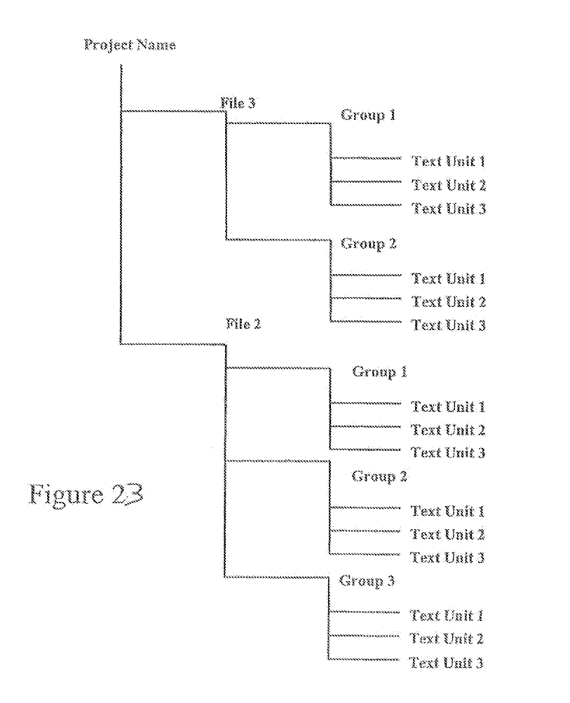

As noted previously, in practice managers will assign particular groups of resources that are to be localised into groups of tasks. To allow this, the database includes a Task table, which consists of plurality of Textunits. These are arranged by the project manager in order to assign a task to a translator. For each task, it is necessary to hold the language that the task is held in (LanguageID), the translator who has been assigned the task (UserID), and the task parent (ParentID) since each task consists of a series of Textunits held in a tree, see FIG. 24.

To identify each game that requires localisation, a project table is provided. This needs to hold the original language (LanguageID). Each project can be subdivided into a sub-project which links back to the project it belongs to (ProjectID), and is identified by a project type (ProjectTypeID) and translation language (LanguageID). Project type contains different types of project that can be applied to any particular game requiring localisation (e.g. localisation for different mobile phones). User Project holds the projects that users are assigned to.

The Language table contains all the languages available for localisation allowing for variations of a particular language. The User Language table holds the languages that translators can localise. The Bug table contains details of any bug or error found while localising. Bug data consists of the ID of the user who reports the bug (SenderID), who the bug details are sent to (ReceiverID), the text details of the bug (Text Data), time that the bug is created (Creation time) and the importance of the bug (Importance).

The Web Interface application uses stored procedures to carry out all of the database queries. This separates the database and the data access layer. In terms of performance, benefits of using stored procedures include the fact that they are optimised the first time the procedure is run and then held in memory for later procedure calls. Another advantage is that the user access rights can be restricted to just the stored procedures and not the underlying tables.

Overall Localisation Process

The localisation process starts with the developer opening a new project file and inputting localisable resources. Once this is done, the resources that are to be localised are stored in the database 12 and the project manager is notified via the manager interface. The manager organises the localisable resources into tasks and assigns those tasks to one or more designated translators. As part of this process, the manager manages a pool of translators, schedules finish dates, and sends messages to notify all concerned when issues arise. Doing this gives considerable feedback on the progress of the localisation as well as issues that might arise in the process. The translators get an overview of their own task list from the translator interface, and subsequently enter the translation screen of FIG. 17 where they can localise the localisable resource, viewing any relevant context information at the same time. The localised resources can then be stored in the database 12. In response to a command from, typically the developer, the localisation management tool 10 is operable to forward the localised project file from the database 12 to the plug-in, where it is converted into a format that is suitable for use by the game engine. Then the plug-in forwards a file format and a resource file to the game engine, which uses these and other resources to build the software.

During build time, the developer specifies which version of the localisable resources they want, for example French. This causes the game engine to use only resources that have been localised for that particular game for French language speakers. The game engine then uses the file format and the French language resources together with the parts of the software that have not been localised in order to build a fully localised program. This can be done at any stage of the development process, but is typically done either once the game application in the original language is complete or when discrete sub-routines or sub-applications are completed. This build process is repeated for each language. Once a program is built, the game engine is used to run it. During run time a developer can identify any problems or errors in the localisation and return to the developer interface to send comments to the appropriate translator.

The present invention provides a system and method for localising computer software, in particular computer games software, which reduces development time, cost and errors. The solution is software oriented; a suite of tools, which all tackle a specific part of the localisation process, supporting translators, project managers and developers to better get to grips with an increasingly difficult process. As a developer, a seamless integration of a localisation system and a database is provided, which enables improved turnaround times for translations and easier language builds. Significantly fewer hours need be spent on localisation bug tracking and the quality of localisations goes up. On the programming side, the invention reduces the work involved in converting localisable resources from a format used in the game to a format for localisation and back again. Furthermore, it provides a solution that can be integrated into the developer's working environment, and a mechanism for automating and enhancing the current way many developers manage localisable data.

A skilled person will appreciate that variations of the disclosed arrangements are possible without departing from the invention. For example, whilst the system described above is web-enabled, it will be appreciated that it could be implemented over any suitable telecommunications network. Equally, whilst the localisation resource management tool and the plug-in manager will typically be located at the developer's premises, they may be provided at a software publisher's premises. Accordingly the above description of the specific embodiment is made by way of example only and not for the purposes of limitation. It will be clear to the skilled person that minor modifications may be made without significant changes to the operation described.

1. A method for localising software involving receiving inputs from a software developer as part of a software development process, the inputs including one or more localisable resource that is to be localised as part of the development process; storing the one or more localisable resource as part of the development process together with an identifier indicative of its location in the software being developed; presenting on a translator interface one or more resource that is to be localised; receiving localised resources input by the translator, and using the localised resources and the identifiers associated with the original localisable resources to localise the software that is being developed.

2. A method as claimed in claim 1 comprising receiving from the developer contextual information relating to the localisable resource; storing that contextual data in association with the localisable resource and providing the contextual information at the translator interface in association with the corresponding localisable resource.

3. A method as claimed in claim 1 wherein the contextual data comprises one or more text files and/or one or more images and/or one or more audio files.

4. A method as claimed in claim 1 wherein a plurality of translators is available and the method comprises allocating one or more localisable resources to a designated one or more of the plurality of translators for localisation.

5. A method as claimed in claim 1 comprising monitoring progress and/or quality of the localised output of each translator.

6. A method as claimed in claim 1 comprising sending to the translator a message with notes or comments relating to a localisation that is in progress, but not finalised, and presenting the message in the translator interface.

7. A method as claimed in claim 1 comprising storing a note on a given localisable resource that is currently being localised in association with that resource and presenting the note in the translator interface.

8. A method as claimed in claim 1 comprising localising the localisable resources into one or more languages or cultures.

9. A software localisation system comprising a development interface for inputting localisable resources; a repository associated with the development interface for storing one or more localisable resource; a translator interface for presenting the one or more localisable resource to the translator, receiving localised resources from the translator and storing them in the repository.

10. A software localisation system as claimed in claim 9 comprising means for using the localised resources and the identifiers associated with the original localisable resources to localise in the developed software.

11. A system as claimed in claim 9 that is operable to receive from the developer contextual information relating to a localisable resource; store that contextual data in association with the localisable resource and provide the contextual information at the translator interface in association with the corresponding localisable resource.

12. A system as claimed in claim 11 wherein the contextual data comprises one or more text files and/or one or more images and/or one or more audio files.

13. A system as claimed in claim 9 wherein a plurality of translators is available and the system is operable to allocate one or more localisable resources to a designated one of the plurality of translators for localisation.

14. A system as claimed in claim 9 that is operable to identify and organise localisable games resources and deposit them in the repository.

15. A system as claimed in claim 9 that is operable to allow remote access and alteration to the repository's resources including communication about and identification of specific and/or changed resources.

16. A system as claimed in claim 9 that is operable to allow access to both original and changed game resources within the repository for use in creating a localised product.

17. A software localisation system comprising: a development interface for allowing development of software that includes localisable resources; a repository associated with the development interface for storing one or more localisable resource, together with an identifier indicative of its location in the software being developed; a localisation interface for allowing a translator to access the one or more localisable resource in the repository, input localised resources, and store the localised resources in the repository, and means for using the localised resources and the identifiers associated with the original localisable resources to localise the developed software.
